(19) United States
(12) Patent Application Publication
(10) Pub. No.: US 2009/0233052 A1
(43) Pub. Date: Sep. 17, 2009

(54) Conductors Having Polymer Insulation On Irregular Surface

(75) Inventors: Gary Thuot, Hockessin, DE (US); Robert Thomas Young, Newark, DE (US); John L. Netta, Newark, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilmington, DE (US)

(21) Appl. No.: 12/403,688

(22) Filed: Mar. 13, 2009

Related U.S. Application Data
(60) Provisional application No. 61/037,060, filed on Mar. 17, 2008.
(60) Provisional application No. 61/123,811, filed on Apr. 10, 2008.

(51) Int. Cl. B32B 3/26; B29C 44/06; B29C 47/20

(52) U.S. Cl. 428/159; 264/45.1; 425/461

(57) ABSTRACT

A communications cable is provided comprising a conductor and polymer insulation encasing said conductor, the polymer insulation having a foamed interior and having an exterior surface formed from longitudinally running rounded peaks and valleys. A process is also provided for producing this polymer insulation or unfoamed polymer insulation having the same or similar peak/valley exterior surface by extruding molten thermoplastic polymer through an orifice to coat a conductor passing through the orifice, thereby forming polymer insulation on the conductor, said orifice defining the exterior surface of said polymer insulation comprising longitudinally running rounded peaks and valleys, said peaks covering at least about 30% of said exterior surface and having a height that is at least 50% of the width of said peaks.

### FIELD OF THE INVENTION

This invention relates to polymer insulation for conductors, wherein the surface of the insulation is contoured to provide advantages in extrusion application of the insulation to the conductor or in communications application of the insulated wire or both.

### BACKGROUND OF THE INVENTION

Normally, polymer insulation is extrusion applied to conductors as a smooth coating having an annular cross-section in the thickness desired to provide the signal transmission properties desired for the particular application. Two types of extrusion processes are generally used, pressure extrusion and melt-draw down extrusion. In pressure extrusion, the molten thermoplastic polymer comes into contact with the conductor within the extrusion die and the extrudate emerging from the die is the polymer-insulated conductor. The diameter of the extrusion orifice establishes the outer diameter of the polymer insulation. In melt draw down extrusion, the molten thermoplastic polymer is extruded as a tube having a larger diameter than the diameter of the conductor, and this tubular shape is drawn down onto the conductor passing into the interior of the extruded tube. This converts the extruded tube of molten polymer into a conical shape, typically referred to as a melt cone. In pressure extrusion, the speed of the conductor advancing though the extrusion die is the same speed as the molten polymer emerging from the die. In melt draw down extrusion, the conductor speed is greater than the extrusion speed, which has the effect of drawing the melt cone to a thinner wall thickness than extruded, whereby the thickness of the polymer insulation is thinner than the thickness of the extruded tube. This drawing out of the melt cone is defined as draw down ratio (DDR), which is the ratio of the cross-sectional area of the polymer insulation as compared to the cross-sectional area of the annular die opening. Thermoplastic fluoropolymers are typically extruded as polymer insulation onto conductors by melt draw down extrusion, because of their extrusion characteristics which limit extrusion rate to low speeds relative to polyolefins, while the easier extruding polyolefins are typically extruded by pressure extrusion to form the polymer insulation on conductors.

Most polymer insulations on conductors are of solid polymer, i.e. unfoamed. Foamed polymer insulations have also been used. In the extrusion foaming technique wherein high pressure inert gas is injected into the molten polymer within the extruder, and melt draw down extrusion is used to form the polymer insulation, the foaming is preferably delayed until the molten polymer contacts the conductor, otherwise the melt cone becomes fragile, and the draw down ratio has to be reduced to avoid cone breakage, causing incompletely coated conductor. The DDR for extrusion foaming is generally within the range of 5 to 30:1, while for unfoamed polymer, the DRR is typically at least 80:1. While foamed polymer insulation offers the advantage of improved dielectric constant and reduced capacitance over solid (unfoamed) polymer insulation, the use of foamed insulation has been limited.

U.S. Pat. No. 5,990,419 addresses the problem of cross talk between a twisted pair of polymer insulated conductors, noting that cross-talk can be reduced by reducing capacitance between the twisted pair, by increasing the center-to-center distance between conductors and by decreasing the dielectric constant of the space between the conductors. This patent acknowledges the existence of foamed insulation, but rejects it in favor of providing solid insulation having longitudinally running ribs extending from the outer surface of the insulation, i.e. increasing its diameter, as shown in FIG. 1. The ribs increase the spacing between conductors and entrap air between the twisted pair of conductors as they abut one another as shown in FIG. 7C, thereby reducing the dielectric constant between the conductors. The disadvantage of this approach is that additional polymer is consumed in the production of the ribs to increase the insulation diameter and its weight.

U.S. Patent Publication 2006/0207786 discloses varying solid polymer insulation cross sections intended to improve impedance uniformity along the length of the twisted pair of insulated conductors. Some of these cross sections entrap air, as shown in FIGS. 9-11. FIG. 12 is disclosed to be the cross section of a conventional dual layered insulated conductor, the inner layer 197 being foamed polymer and the outer layer 198 being solid polymer, with the inner layer disclosed as having less strength than the outer layer and disadvantageously requiring the step of foaming [0050].

The low strength of the foamed polymer insulation as compared to solid polymer insulation is a problem when force is applied to the foamed insulation, which tends to crush the foamed insulation, thereby reducing the effective insulation thickness. Crushing force is present for example when a pair of foamed polymer insulated conductors is twinned, i.e. twisted together to form a twisted pair of polymer insulated conductors. As the lay of the twist is shortened from about 0.5 in (12.7 mm) to about 0.3 in (7.6 mm), the crushing force increases. The crush of the foamed insulation can be compensated by increasing the thickness of the foamed insulation, but this has the disadvantage of increasing the size of the cable and using a greater amount of polymer.

U.S. Pat. No. 5,990,419 and U.S. Patent Publication 2006/0207786, instead of addressing their problems by working with foamed polymer insulation, abandon such insulation in favor of proposing various solid polymer insulation configurations.

### SUMMARY OF THE INVENTION

The present invention in one aspect, provides a foamed polymer-insulated conductor that ameliorates the crush problem, thereby enabling the dielectric and capacitance advantages to be realized for communications cable without increasing the size of the cable. This cable comprises a conductor and polymer insulation encasing said conductor, said polymer insulation having a foamed interior and having an exterior surface formed from longitudinally running rounded peaks and valleys. The surface of the polymer insulation has a corrugated appearance, except that for the diameter of the insulation typically used to form twisted pairs of conductors, e.g. 45 mils (1.14 mm), the insulated conductor is so small in cross section that the corrugated appearance is hardly visible to the naked eye. The rounding of the peaks improves their formation by extrusion to form the polymer insulation of the conductor. The effect of the peaks along the exterior surface of the polymer insulation is to resist crushing. This crush resistance is enhanced by the following aspects of the peaks: (a) the density of the peaks is greater than the density of the foamed interior, (b) the polymer insulation can have an unfoamed layer at the exterior surface of said peaks, or (c) the peaks are unfoamed. The greater density of the peaks as compared to the interior of the foamed insulation increases crush resistance. Having an unfoamed layer at the surface of the peaks is another way of increasing peak density. Such layer acts as a dome (crest), resisting crushing. The extrusion process can be carried out to provide the unfoamed layer at the entire exterior surface of the polymer insulation, whereby both peaks and valleys have this unfoamed outer layer. The entire peaks can be unfoamed, which also resists crushing of the polymer insulation.

The number of peaks present will depend on the diameter of the polymer insulation. As diameter increases, so does circumference, which means that the peak width chosen for a small diameter polymer insulation, if used on a larger diameter polymer insulation, will require more peaks. The peaks are not tall and thin, because such configuration does not improve crush resistance. Such peaks tend to fold over upon themselves upon being subjected to crushing. The peaks used in the present invention have sufficient width relative to height that they do not fold during crushing. Preferred quantitative characterizations of the peaks are independently as follows: (i) the height of the peaks is no greater than about 150% of the width of said peaks, (ii) the peaks cover at least about 30% of the exterior surface (the footprint of the peaks on the valley circumference) of the polymer insulation, and (iii) the peaks have a height that is at least about 50% of the width of the peaks. As the width of the peaks decrease, the number of the peaks should be increased to provide equivalent improvement. For the very small size (diameter) communications cable, such as wherein the overall thickness of insulation is about 6 to 14 mils (0.150 to 0.360 mm), and the height of said peaks is at least about 25% of said total thickness. Overall thickness is the thickness of the insulation from the conductor surface to the top of the peaks. The width of the peaks is the distance across the base of the peaks where they intersect with the valleys. The height of the peaks is measured from the circumference defined by the valleys (valley circumference) to the top of the peaks.

The process for making the communications cable described above comprises extruding a foamable molten thermoplastic polymer onto the conductor and foaming said polymer on said conductor to thereby obtain the encasing of the conductor to form the polymer insulation having a foamed interior, said extruding including forming said longitudinally running peaks and valleys as said exterior surface of said polymer insulation. The extrusion can be pressure extruding or melt draw down extruding.

Provision of the peaks on the exterior surface of the polymer insulation by extrusion can increase extrusion difficulty, i.e. can require the extrusion rate (speed) to be reduced in order to maintain the dimensions of the peaks. If the extrusion is too fast, the molten thermoplastic polymer tends to extrude non-uniformly in the peak area, giving rise to periodic peak thinning and/or shortening in height. This can be avoided by decreasing the rate of extrusion, but at a loss in production. Another aspect of the present invention is the extrusion process that minimizes this extrusion difficulty by the design of the extruded peak. Such process comprises extruding molten thermoplastic polymer through an orifice to coat a conductor passing through said orifice, thereby forming polymer insulation on said conductor, said orifice defining the exterior surface of said polymer insulation comprising longitudinally running rounded peaks and valleys, said peaks covering at least about 30% of said exterior surface and having a height that is at least 50% of the width of said peaks. The width of the peaks and their rounding minimize to eliminate any adverse effect on extrusion rate. The details of the peaks described above apply to this process and the process mentioned in the preceding paragraph. The non-foldability of the peaks, meaning that the peaks are not narrow, importantly contributes to this extrusion benefit.

This process aspect of the invention is applicable to pressure extruding or melt draw down extruding. In the case of melt draw down extruding, the rounded peaks are also draw down, whereby the peaks on the polymer insulation are smaller than the peaks extruded from the orifice. This process aspect of the present invention is applicable to forming solid polymer insulation, i.e. unfoamed, and to forming foamed polymer insulation. In the case of foamed polymer insulation, the extrusion process includes the additional step of foaming the polymer insulation, preferably when in contact with the conductor. The presence of the peaks in the melt cone formed in melt draw down extrusion, whether of solid polymer, i.e. not to be foamed, or of polymer that is to be foamed when in contact with the conductor, strengthens the melt cone, thereby enabling the DDR to be increased, resulting in improved production.

In all the polymer insulations of and made by the processes of the present invention, the polymer can be any thermoplastic polymer that is extrudable for coating a conductor and that has the electrical, physical, and thermal properties desired for the particular communications application. The most common such polymer insulations are polyolefin and fluoropolymer, and these polymers can be used in the present invention. Non-fluorinated polymer other than polyolefin can also be used.

Another aspect of the present invention is the extrusion die for making the polymer insulation, as follows: An extrusion die for the extrusion of molten thermoplastic polymer onto a conductor to form polymer insulation thereon, said die having a surface forming the exterior surface of said polymer insulation, said die surface having a series of radially spaced, longitudinally running rounded grooves, whereby the exterior surface of said polymer insulation has longitudinally running rounded peaks and valleys, said peaks corresponding to said grooves in said die surface, said extrusion die including a guide for centering a conductor within said polymer insulation. The detail of the peaks described above apply to the grooves forming these peaks. In the case of pressure extrusion, the size of the die surface (orifice) will generally be the size of the polymer insulated conductor, and the size of the extruded peaks will generally be the same as the size of the peaks in the surface of the polymer insulation. In the case of melt draw down extrusion, the extruded tube and the peaks in its exterior surface will be larger than the corresponding dimension for the polymer insulation formed on the conductor. The shrinkage in size will depend on the draw down ratio used.

### BRIEF DESCRIPTION OF THE DRAWINGS

FIG. 1 is an enlarged perspective view of one embodiment of an indeterminate length of foamed polymer-insulated conductor of the present invention.

FIG. 2 is a further enlarged cross sectional view of another embodiment of foamed polymer insulation of the present invention;

FIG. 3 is a further enlarged cross sectional view of still another embodiment of foamed polymer insulation of the present invention;

FIG. 4 is a further enlarged cross sectional view of still another embodiment of foamed polymer insulation of the present invention;

FIG. 5 is a further enlarged fragmentary cross sectional view of still another embodiment of foamed polymer insulation of the present invention;

FIG. 6 shows a fragmentary cross sectional view of several embodiments of extruder cross head design for obtaining polymer insulation and carrying out processes of the present invention; and

FIG. 7 shows a fragmentary cross sectional view of the extrusion die of FIG. 6.

### DETAILED DESCRIPTION OF THE INVENTION

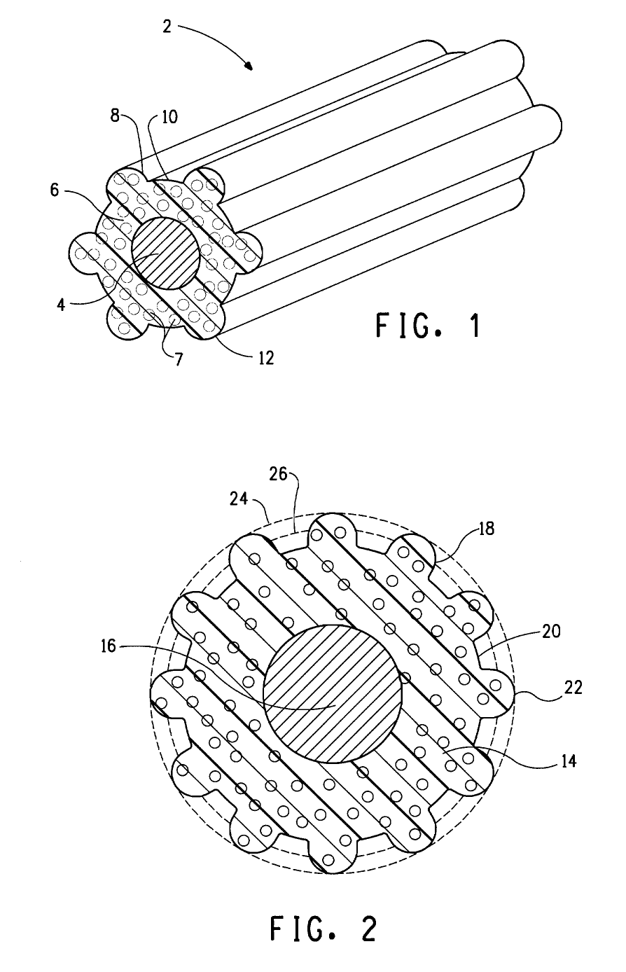

In FIG. 1, the polymer-insulated conductor 2 comprises a conductor 4 and foamed polymer insulation 6 encasing the conductor. The voids providing the foamed aspect of the polymer insulation 6 are approximately spherical in shape and are shown in FIG. 1 as small circles 7 within the insulation. The conductor 4 is centered within the polymer insulation 6. The exterior surface of the polymer insulation 6 is composed of peaks 8 and valleys 10 running along the length of the polymer-insulated conductor 2. The peaks 8 and valleys 10 alternate with one another, i.e. the valleys separate adjacent peaks from one another. The tops 12 of the peaks 8 are rounded. In the embodiment of FIG. 1, there are six peaks 8 and six valleys 10 and the valleys have a width that comprises longitudinally running areas on the exterior surface of the polymer insulation. The number of peaks and intervening valleys, and the width of the peaks (at their base) and of the valleys can be selected according to the communications application intended for the polymer-insulated conductor 2.

In FIG. 2, the foamed polymer insulation 14 encasing conductor 16 has twelve alternating longitudinally running peaks 18 and valleys 20, with the tops 22 of the peaks being rounded.

The embodiment of FIG. 2 has three diameters (circumferences), an outer diameter 24 represented by phantom line sand defined by the tops of the peaks, an intermediate diameter 26 represented by phantom lines, and an inner diameter defined by the circumference of the valleys 20. The intermediate diameter 26 is the diameter of the same weight of foamed polymer insulation 14 when extruded as a uniform thickness polymer insulation (and same void content) instead of having peaks and valleys. The peaks can be simply added onto this intermediate diameter, but preferably the same weight of polymer insulation is redistributed to form the peak/valley configuration, wherein the outer diameter 24 is greater than the intermediate diameter 26, but the inner diameter represented by the distance across opposing valleys 20 is less than the intermediate diameter as shown in FIG. 2. When the peaks 18 are subjected to a crushing force, they tend to reduce the outer diameter of the foamed polymer insulation 14 towards the intermediate diameter. In contrast, when the polymer insulation is of uniform thickness and has the intermediate diameter 26 as the outer diameter, the same crushing force tends to reduce the intermediate diameter towards the inner diameter 20, thereby reducing the effective thickness of the insulation as compared to when the peaks and valleys are present. The greater effective thickness (after crushing) of the insulation having peaks and valleys forming its exterior surface, such as according to FIG. 2, is shown by the fact that the impedance desired for a twisted pair of foamed polymer-insulated conductors can be achieved without increasing the amount of polymer to compensate for the insulation thickness lost in crushing. Instead, impedance improvement can be obtained by decreasing the amount of polymer from the amount needed to form a uniform thickness foamed polymer insulation of the same void content.

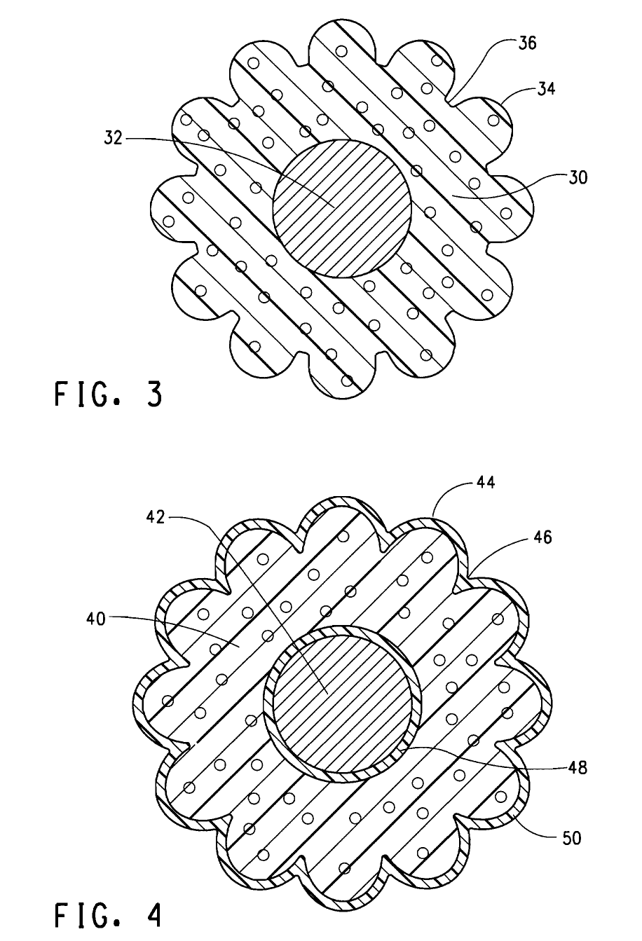

In FIG. 3, the foamed polymer insulation 30 encasing the conductor 32 has the same number of longitudinally running peaks 34 and valleys 36 as the peaks 18 and valleys 20 in FIG. 2, but the peaks 34 are wider and the valleys are narrower as shown in FIG. 3. As in FIG. 2, the peaks 34 are rounded at their tops.

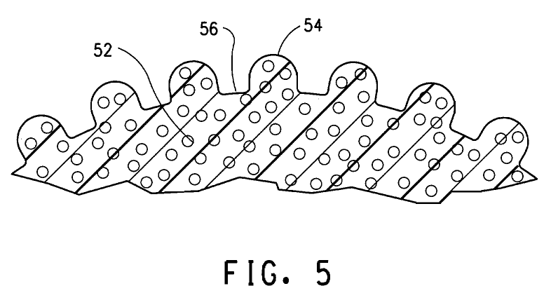

In FIG. 4, the foamed polymer insulation 40 encasing the conductor 42 has the same number of longitudinally running peaks 44 and valleys 46 as in FIG. 3, but the peaks 44 are wide enough that the valleys 46 have little to no width. In this embodiment, the valleys 46 are simply the location of the intersection (interconnection) of adjacent peaks 44. The tops of peaks 44 are rounded.

The embodiment of FIG. 4 shows additional features that may be present in this embodiment and the other embodiments of foamed polymer insulation of the present invention. The foamed polymer insulation 40 can include an unfoamed layer 48 on its interior surface running the length of the polymer insulation, this unfoamed layer being in contact with the conductor 42. The foamed polymer insulation 40 can also include an unfoamed layer 50 at its exterior surface running the length of the polymer insulation 40. Both layers can be formed during extrusion by the rapid chilling effect of the exterior surface of the extrudate forming the polymer insulation, thereby forming layer 50, and by the chilling effect of the conductor when it comes into contact with the molten polymer insulation in the extrusion process forming layer 48. Preferably the temperature of the conductor, while being heated to present a hot surface to the foamed polymer forming the insulation thereon, is at a temperature typically no greater than about 240° F. (116° C.), which when the polymer is fluoropolymer is much less than the temperature of the molten polymer, usually at least 350° C. The effect of this chilling is to cool the molten polymer sufficiently to prevent foaming from occurring, while the interior of the polymer insulation is foamed. In this case, the interior of the polymer insulation is the area (in cross section) between the unfoamed layers. The thickness of the layers 48 and 50 are independent of one another, being dependent on the chilling effect from different sources. Although layers 48 and 50 are shown as lines separating these layers from the interior of the foamed polymer insulation 40, these layers are incorporated into the polymer insulation via a zone of transition wherein the foam density changes from unfoamed to the foam density of the interior of the foamed polymer insulation 40. By “unfoamed” is meant that under a magnification of 40×, virtually no voids are visible in the regions at the interior and exterior surfaces of the foamed polymer, which can be considered as being the unfoamed layers, such as layers 48 and 50. An occasional void may be present in these layers arising from volatilization of a low boiling fraction, such as oligomer, present in the thermoplastic polymer. The thickness of unfoamed layers at one or both of the exterior and interior insulation surfaces, where voids are only occasional or not at all, certainly much less than the void content of the interior of the insulation, should preferably not total more than 25% of the overall thickness of the insulation. If present, the unfoamed layers are each at least about 1 (0.025 mm) to 2 mils (0.05 mm) thick.

The presence of the rounded tops of peaks 18 (FIG. 2), 34 (FIG. 3) and 44 (FIG. 4), together with the width of the peaks resists crushing. The rounded tops provide crush resistance by themselves. For this effect to be realized, the peaks need to be wide enough that they do not fold over upon themselves upon the application of the crushing force experienced in the manufacture of communications cable. In FIG. 2, e.g., the width would be measured at the circumference of the polymer insulation defining the valleys 20. In FIG. 4, the valleys have no measurable width, but the peak interconnections (intersections) forming these valleys also define an inner diameter and circumference of the foamed insulation from which the width of the peaks can be measured. Preferably, the peaks are at least 75% as wide, more preferably at least 100% as wide, as they are high.

The presence of the unfoamed layer the exterior surface of the foamed polymer insulation, such as shown by layer 50 in FIG. 4, increases the resistance to crushing of the peaks and thus of the foamed polymer insulation. This arises from the dome shape of the unfoamed layer, such as layer 50, and its interconnection with that portion of the unfoamed layer present in the valleys between the peaks. The presence of the unfoamed layer along the interior surface of the insulation at the surface of the conductor, such as layer 48 of FIG. 4, prevents voids from being present at the conductor surface to cause return loss in the communicated signal.

The number of peaks and therefore the number of valleys forming the exterior surface of the foamed polymer insulation of the present invention will vary, depending on the width of the peaks and diameter of the foamed polymer insulation, which determines the circumference from which the peaks extend. Generally, the foamed polymer insulation will have at least 5 peaks. FIGS. 2-4 show the same number of peaks (12) to enable visual comparison when the width of the peaks is increased. All of these polymer insulations have a relatively small diameter, wherein the height of the peaks represent a relatively large % of the overall thickness of the insulation, measured as described above, e.g. at least 25% of the total thickness. FIG. 5 shows a much thicker foamed polymer insulation 52, i.e. having a large diameter, wherein the peaks 54 and valleys 56 are of the same width as the peaks 18 and valleys 20 in FIG. 2. The eight peaks 54 visible in FIG. 5 cover only a small portion of the exterior surface of this foamed polymer insulation. Many more peaks 54 than the twelve peaks adequate to encircle the foamed polymer insulation of FIG. 2 will be required to achieve the same effect for the embodiment of FIG. 5.

The overall thickness of the polymer insulation (distance from conductor surface to top of peak), including any outer surface and inner surface unfoamed layers, such as layers 48 and 50 of FIG. 4, if present is generally from about 4 to 20 mils (0.1 to 0.5 mm), preferably about 6 to 14 mils (150-350 μm) for such applications as twisted pairs of insulated conductors for communications cable. These same minimum dimensions apply for other communications applications, except that the maximum overall thickness can be greater, e.g. up to about 100 mils (2.5 mm) for other applications, such as coaxial cable, wherein the foamed polymer insulation separates the central conductor from the outer conductor usually applied by braiding onto the polymer insulation and the overall insulation thickness will typically be from about 15 mils (0.38 mm) to 100 mils (2.5 mm). Generally, a metallized plastic film such as of polyester will be wrapped around the exterior surface of the polymer insulation, bridging the valleys prior to braiding, with the metallized surface of the film facing the braiding. Also generally, a jacket is applied over either the twisted pair or coaxial constructions to complete the communications cable. Multiple twisted pairs can be bundled together in a single jacket.

For the twisted pair insulation thicknesses, the height of the peaks, as disclosed above, is preferably at least 25% of the thickness of the overall polymer insulation, more preferably at least 30%, and even more preferably, at least 40% thereof. Generally, folding of the peaks during crushing is avoided if the height of the peaks is no more than 150% of the width of the peaks, preferably no more than 125%, and more preferably no more than 100% thereof. Of course, the peaks are also wide enough that they do not fold upon crushing, which is generally obtained when the width of the peaks are at least 75% of the peak height, more preferably at least 100%, and even more preferably, at least 125% of the peak height. Another indication of the peak width is the coverage of the peaks on the circumference of the polymer insulated cable, the circumference in this case meaning the inner diameter of the foamed polymer insulation represented by the surface (floor) of the valleys. Preferably, the peaks cover at least 35%, and more preferably at least 40%, and even more preferably, at least 50% of the circumference (valley surface) of the foamed polymer insulation.

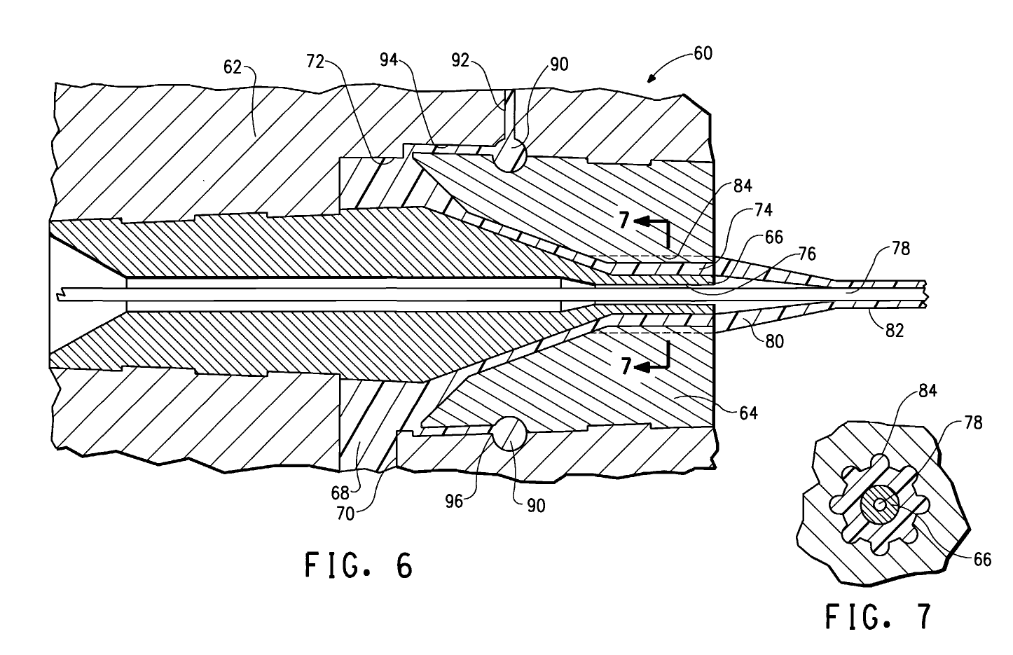

One embodiment for making the foamed polymer insulated conductor is the melt draw down extrusion shown in FIG. 6. In FIG. 6 the extruder crosshead 60 is concentrically fitted with a body 62, a die 64 and die tip 66. Molten thermoplastic polymer 68, pressurized (injected) with inert gas, is fed into the die 64 through a port 70 from an extruder (not shown), and the crosshead body 62 contains a circumferential channel 72, with respect to the die tip 66, enabling this molten polymer to flow entirely around the die tip and into and though the narrowed annular gap (orifice) 74 between the die 64 and die tip 66. The die tip 66 has an axial wire (conductor) guide 76 for concentrically guiding conductor 78 into the cone 80 of molten thermoplastic polymer formed by extrusion from the annular orifice 74 between the die 64 and die tip 66. The annular orifice 74 defines the extruded dimension of the tubular shape of molten polymer composition that is drawn down by a vacuum, imposed through the wire guide 76, to form the cone 80, which terminates as the polymer insulation 82 coats the conductor 78. The foaming of the molten polymer insulation is made possible by the release in pressure accompanying the emergence of the molten polymer from die 64, but is nevertheless delayed until the polymer is drawn down onto the conductor, whereupon the foaming occurs and the thus foam-insulated conductor is cooled to freeze the foam construction.

The annular orifice contains a series of grooves 84 running in the direction of extrusion, which as best seen in FIG. 7 are radially spaced, preferably uniformly, about the outer surface of the annular orifice 74. The grooves form the peaks and valleys in the exterior surface of the foamed polymer insulation. In the embodiment shown in FIG. 7, the eight grooves 84 will form eight peaks and valleys as the exterior surface of the foamed polymer insulation. As shown in FIG. 6, the wall thickness of the cone 80 as it emerges from the annular orifice 74 is greater than the wall thickness of the foamed polymer insulation formed on the conductor 78. The as-extruded peaks (not shown) are also larger in size than the final dimension of the peaks forming the exterior surface of the foamed polymer insulation. At a given rate of extrusion of the molten thermoplastic polymer, the speed of the conductor passing through the wire guide 76 is greater so as to achieve the draw down ratio desired. The higher the draw down ratio (DDR), the greater the thinning out of the wall thickness of the cone and the peaks on the surface of the cone, and the greater the production rate of foamed polymer insulated conductor. One skilled in the art knows how to size the annular orifice in order to obtain the foamed polymer insulation dimensions desired at the DDR being used. Typically, the length of the cone such as cone 80 in FIG. 6, is limited in order to bring the molten polymer into contact with the conductor before foaming begins. In an extrusion coating production line, the commencement of foaming (not shown in FIG. 6) is generally visible to the naked eye by the change in appearance of the molten polymer, e.g. converting from a translucent appearance to an opaque appearance for unpigmented polymer. Thus, the DDR for producing foamed polymer insulation is small relative to the production of unfoamed polymer insulation, and is typically within the range of 20:1 to 30:1. The process of the present invention can achieve these draw down ratios and higher even though the foamed polymer insulation is not of uniform thickness. The presence of the longitudinally running peaks in the cone strengthen the cone, thereby contributing to the attainment of higher DDR and the resultant increase in production rate of foamed polymer insulated conductor.

As discussed above, the chilling of the molten polymer from the die 64 provides an unfoamed layer of polymer at the exterior surface of the foamed polymer insulation. The presence of this unfoamed layer increases the average density of the peaks as compared to the density of the foamed polymer insulation within its interior. This increase in density in itself increases the crush resistance of the peaks and thus of the foamed polymer insulation. The process of the present invention achieves this effect by extrusion of molten thermoplastic polymer from a single source, i.e. using a single extruder. In this embodiment, all the polymer forming the foamed polymer insulation comes through port 70 in the cross head 60.

In another embodiment of the present invention, the cross head 60 in FIG. 6 is modified to form an unfoamed layer at the exterior surface of the foamed polymer insulation that is not dependent on the chilling effect of the die 64, if it is desired to increase the thickness of the unfoamed layer and the average density of the peaks. According to this embodiment, an annular channel 90 is provided, formed between the body 62 and die 64. The body 62 is also provided with a port 92, which is fed with molten polymer from a second extruder (not shown). This enables the molten polymer to encircle the die 64. The crosshead body 62 is further modified to form an annular gap 94 surrounding the die 64 and the annular channel 90 includes an annular opening 96. This modification enables the molten polymer flowing through port 92 to flow into the annular space 94 and then into contact with the molten polymer entering the die from port 70. The molten polymer flowing from annular space 94 flows along the outer wall of the die 64 to emerge from the annular orifice 74 as an outer unfoamed layer conforming to the grooves in the die, such as grooves 84 in die 64, to provide the unfoamed layer at the exterior surface of the peaks and valleys of the foamed polymer insulation of the present invention. The molten polymer entering the body 62 via port 92 has not been pressurized with inert gas, whereby this molten polymer is non-foamed while the underlying molten polymer foams once in contact with the conductor. The thickness of this outer layer, such as layer 50 of FIG. 4, is controlled by the relative flow rates of the molten polymer flowing through port 92 and the molten foamable polymer flowing through port 70.

Another modification not shown in FIG. 6 would be to provide a channel similar to channel 90 for communicating directly with the grooves 84 in the die 64. Such communication can be obtained by passageways (not shown) communicating between the new channel and each groove 84. The new channel would be located relative to the grooves to enable these ports to be machined into the die. According to this modification, the amount of molten polymer fed through port 92 from a second extruder (not shown), would be enough to supply the thickness of unfoamed polymer layer in the peaks of the foamed polymer insulation desired, possibly making substantially all of the peaks as unfoamed polymer. In the practice of this embodiment, it may not be necessary to supply the unfoamed layer via molten polymer fed through annular space 94.

Any method for foaming the polymer to form the foamed regions of the polymer insulation can be used. It is preferred, however, that the method used will obtain cells (voids) that are both small and uniform in approximate spherical shape for the best combination of electrical properties, such as low return loss and high signal transmission velocity. In this regard, the cells are preferably about 50 micrometers in diameter and smaller and the average void content is about 10 to 70%. For twisted pairs, the void content of the polymer insulation will typically be about 15 to 35%. For coaxial cable, the average void content will be about 10-70%. Average void content is determined by comparing the weight of the foamed insulation with the weight of unfoamed insulation (same polymer) of the same dimensions according to the following equation;

Void content(%)=100(1−[foamed wt/unfoamed wt]).

This is the average void content of the foamed together with the unfoamed portions of the insulation. The preferred method for obtaining this foam result in the foamed regions of the insulation is the use of high pressure inert gas injection into the molten polymer in the extruder, as mentioned above, feeding through port 70 (FIG. 6) and having the molten polymer contain foam cell nucleating agent, which initiates the formation of small uniform size cells when foaming occurs downstream from the extrusion die. The foaming caused by the high pressure inert gas injection delays itself long enough for the extruded tube of polymer to be drawn down onto the conductor before foaming begins. Preferably, the foam cell nucleating agent added to the polymer used in the present invention is thermally stable under extruder processing conditions. Examples of such agents include those disclosed in U.S. Pat. No. 4,877,815 (Buckmaster et al.), namely thermally stable organic acids and salts of sulfonic acid or phosphonic acid, preferably in combination with boron nitride and a thermally stable inorganic salt disclosed in U.S. Pat. No. 4,764,538. The preferred organic acid or salt has the formula F(CF₂)ₙCH₂CH₂-sulfonic or phosphonic acid or salt, wherein n is 6, 8, 10, or 12 or a mixture thereof.

If unfoamed inner and outer layers were present in the foamed polymer insulation, the void content of the interior of the insulation can be increased to compensate for the unfoamed layers, i.e. to provide the same average void content and same capacitance as though no unfoamed layers were present, by increasing the pressure of the inert gas injected into the molten polymer.

The process of the present invention for producing foamed polymer insulation is also applicable to pressure extrusion coating of the conductor. In pressure extrusion coating the die would be similar to that of FIG. 7, except that the annular gap and the grooves forming the peaks and valleys would be smaller, about the same size as desired for the foamed polymer insulation dimensions. The crosshead of FIG. 1 would also be modified so that the die tip terminates within the die so that the foamable molten thermoplastic polymer comes into contact with the conductor within the die, whereby the conductor emerges from the die with the foamable polymer coating already present thereon. The speed of passage of the conductor through the wire guide would be the same as the rate of extrusion of the molten polymer. Foaming in pressure extrusion can be obtained in the same way as in melt draw down extrusion.

Another aspect of the present invention is the extrusion coating process, by either melt draw down extrusion or pressure extrusion, to form polymer insulation having peaks and valleys like those described above as the exterior surface of the polymer insulation, wherein the polymer insulation can either be foamed as described above or entirely unfoamed. To produce the unfoamed polymer insulation, the steps of producing the foam, e.g. high pressure injection of inert gas and incorporation of foam cell nucleating agent, is omitted from the extrusion coating process. Of course the features of producing unfoamed layers at the outer and/or inner surfaces of the foamed polymer insulation would also be unnecessary, because the entire polymer insulation would be unfoamed (solid).

According to this aspect of the present invention, the rounding of the peaks and the width of the peaks are such as to permit the extrusion rate to be increased, without producing distortion of the peaks in the final polymer insulation. If the peaks were too narrow and/or if the peaks were characterized by sharp corners, such as shown in FIG. 1 of U.S. Pat. No. 5,990,419, the extrusion rate is limited, causing a sacrifice in production rate. The rounding of the peaks is more or less circular in cross section as shown for the foamed polymer insulations of FIG. 2-4. This is a convenient form of rounding, because the grooves in the die that produces this rounding of the peaks is most conveniently made by using tooling that produces a circular cross section for the grooves. The peaks, however, can have other configurations at their tops, so long as no sharp corners are present. For example, the peak top can be formed as a small flat area bounded on both sides by rounding into the sides of the peak. In this embodiment of the process of the present invention, it is preferred that the peak be at least as wide as the peak is high, i.e. the peak width is at least 100% of the height of the peak and the peak height is at least 50% of the peak width. The % of insulation circumference occupied by the peaks as described for the unfoamed polymer insulation above is also applicable to this embodiment of the present invention. When melt draw down extrusion is used to produce unfoamed polymer insulation, the DDR is preferably at least 50:1 and more preferably at least 70:1.

In the processes and product of the present invention, the peaks and valleys are continuous along the entire length of the insulation and are parallel (as extruded) to the conductor. The polymer-insulated conductors are twinned to form a twisted pair. In the course of twinning the individual polymer-insulated conductors are first back twisted by the twinning machine, followed by the pair of polymer-insulated conductors being twisted together. The effect of the back twisting is to change the disposition of the peaks and valleys on the insulation exterior surface, from parallel to helical. The twinning is carried out with the helical longitudinally running peaks and valleys of the two polymer-insulated conductors being disposed in the same direction. The twinning of the longitudinally running helical peaks and valleys thus results in a peak from one insulation nesting within a valley of the other insulation of the twisted pair.

Examples of fluoropolymer that can be used as the polymer insulation, whether to form unfoamed insulation, with or without an unfoamed surface layer, or an unfoamed polymer insulation are preferably copolymers of tetrafluoroethylene (TFE) and hexafluoropropylene (HFP). In these copolymers, the HFP content is typically about 6-17 wt %, preferably 9-17 wt % (calculated from HFPI×3.2). HFPI (HFP Index) is the ratio of infrared radiation (IR) absorbances at specified IR wavelengths as disclosed in U.S. Statutory Invention Registration H130. Preferably, the TFE/HFP copolymers include a small amount of additional comonomer to improve properties. The preferred TFE/HFP copolymer is TFE/HFP/perfluoro(alkyl vinyl ether) (PAVE), wherein the alkyl group contains 1 to 4 carbon atoms. Preferred PAVE monomers are perfluoro(ethyl vinyl ether) (PEVE) and perfluoro(propyl vinyl ether) (PPVE). Preferred TFE/HFP copolymers containing the additional comonomer have an HFP content of about 6-17 wt %, preferably 9-17 wt % and PAVE content, preferably PEVE, of about 0.2 to 3 wt %, with the remainder of the copolymer being TFE to total 100 wt % of the copolymer. Examples of FEP compositions are those disclosed in U.S. Pat. No. 4,029,868 (Carlson), U.S. Pat. No. 5,677,404 (Blair), and U.S. Pat. No. 6,541,588 (Kaulbach et al.) and in U.S. Statutory Invention Registration H130. The FEP is partially crystalline, that is, it is not an elastomer. By partially crystalline is meant that the polymers have some crystallinity and are characterized by a detectable melting point measured according to ASTM D 3418, and a melting endotherm of at least about 3 J/g.

Other fluoropolymers can be used, i.e. polymers containing at least 35 wt % fluorine, that are melt fabricable so as to be melt extrudable, but FEP is preferred because of its high speed extrudability and relatively low cost. In particular applications, ethylene/tetrafluoroethylene (ETFE) polymers will be suitable, but perfluoropolymers are preferred, these including copolymers of tetrafluoroethylene (TFE) and perfluoro(alkyl vinyl ether) (PAVE), commonly known as PFA, and in certain cases MFA. PAVE monomers include perfluoro(ethyl vinyl ether) (PEVE), perfluoro(methyl vinyl ether) (PMVE), and perfluoro(propyl vinyl ether) (PPVE). TFE/PEVE and TFE/PPVE are preferred PFAs. MFA is TFE/PPVE/PMVE copolymer. However, as stated above, FEP is the most preferred polymer.

The fluoropolymers used in the present invention are also melt-fabricable, i.e. the polymer is sufficiently flowable in the molten state that it can be fabricated by melt processing such as extrusion, to produce wire insulation having sufficient strength so as to be useful. The melt flow rate (MFR) of the perfluoropolymers used in the present invention is preferably in the range of about 5 g/10 min to about 50 g/10, preferably at least 20 g/10 min, and more preferably at least 25 g/10 min.

MFR is typically controlled by varying initiator feed during polymerization as disclosed in U.S. Pat. No. 7,122,609 (Chapman). The higher the initiator concentration in the polymerization medium for given polymerization conditions and copolymer composition, the lower the molecular weight, and the higher the MFR. MFR may also be controlled by use of chain transfer agents (CTA). MFR is measured according to ASTM D-1238 using a 5 kg weight on the molten polymer and at the melt temperature of 372° C. as set forth in ASTM D 2116-91a (for FEP), ASTM D 3307-93 (PFA), and ASTM D 3159-91a (for ETFE).

Fluoropolymers made by aqueous polymerization, as-polymerized contain at least about 400 end groups per 10⁶ carbon atoms. Most of these end groups are unstable in the sense that when exposed to heat, such as encountered during extrusion, they undergo chemical reaction such as decomposition, either discoloring the extruded polymer or filling it with non-uniform bubbles or both. Examples of these unstable end groups include —COF, —CONH₂, —COOH, —CF═CF₂ and/or —CH₂OH and are determined by such polymerization aspects as choice of polymerization medium, initiator, chain transfer agent, if any, buffer if any. Preferably, the fluoropolymer is stabilized to replace substantially all of the unstable end groups by stable end groups. The preferred methods of stabilization are exposure of the fluoropolymer to steam or fluorine, the latter being applicable to perfluoropolymers, at high temperature. Exposure of the fluoropolymer to steam is disclosed in U.S. Pat. 3,085,083 (Schreyer). Exposure of the perfluoropolymer to fluorine is disclosed in U.S. Pat. No. 4,742,122 (Buckmaster et al.) and U.S. Pat. No. 4,743,658 (Imbalzano et al.). These processes can be used in the present invention. The analysis of end groups is described in these patents. The presence of the —CF₃ stable end group (the product of fluorination) is deduced from the absence of unstable end groups existing after the fluorine treatment, and this is the preferred stable end group, providing reduced dissipation factor as compared to the —CF₂H end group stabilized fluoropolymer (the product of steam treatment). Preferably, the total number of unstable end groups constitute no more than about 80 such end groups per 10⁶ carbon atoms, preferably no more than about 40 such end groups per 10⁶ carbon atoms, and most preferably, no greater than about 20 such end groups per 10⁶ carbon atoms.

Examples of non-fluorinated thermoplastic polymers include polyolefins, polyamides, polyesters, and polyaryleneetherketones, such as polyetherketone (PEK), polyetheretherketone (PEEK), and polyetherketoneketone (PEKK).

Examples of polyolefins that can be used as foamed or unfoamed insulation according to the present invention include polypropylene, e.g. isotactic polypropylene, linear polyethylenes such as high density polyethylenes (HDPE), linear low density polyethylenes (LLDPE), e.g. having a specific gravity of 0.89 to 0.92. The linear low density polyethylenes made by the INSITE® catalyst technology of Dow Chemical Company and the EXACT® polyethylenes available from Exxon Chemical Company can be used in the present invention; these resins are generically called (mLLDPE). These linear low density polyethylenes are copolymers of ethylene with small proportions of higher alpha monoolefins, e.g. containing 4 to 8 carbon atoms, typically butene or octene. Any of these thermoplastic polymers can be a single polymer or a blend of polymers. Thus, the EXACT® polyethylenes are often a blend of polyethylenes of different molecular weights.

The polyolefins are easier to extrude than fluoropolymers in the sense that polyolefins can be extruded faster than fluoropolymers without causing defects in the polymer insulation, such as surface roughening indicating the onset of melt fracture, dimensional irregularities or gaps in the insulation. Thus, the polyolefins used to form polymer insulations according to the present invention can obtain adequate production rate when pressure extrusion coating is used. Fluoropolymers will generally require the use of melt draw down extrusion to obtain adequate production rate. The polymer forming the insulation can also contain other additives that are commonly used in polymer insulations, such as pigments, extrusion aids, fillers, flame retardants, and antioxidants, depending on the identity of the polymer being used and properties to be enhanced.

The conductor used in the present invention is any material that is useful for transmitting signals as required for service in a communications cable. Such material can be in the form of a single strand or can be multiple strands twisted together or otherwise united to form a unitary strand. The most common such material is copper or copper containing. For example, cooper conductor may be plated with a different metal such as silver, tin or nickel.

### EXAMPLES

The fluoropolymer used in these Examples is a commercially available (from DuPont) fluoropolymer containing 10 to 11 wt % HFP and 1-1.5 wt % PEVE, the remainder being TFE. This FEP has an MFR 30 g/10 min and has been stabilized by exposure to fluorine using the extruder fluorination procedure of Example 2 of U.S. Pat. No. 6,838,545 (Chapman) except that the fluorine concentration is reduced from 2500 ppm in the '545 Example to 1200 ppm. The foam cell nucleating agent is a mixture of 91.1 wt % boron nitride, 2.5 wt % calcium tetraborate and 6.4 wt % of the barium salt of telomer B sulfonic acid, to total 100% of the combination of these ingredients, as disclosed in U.S. Pat. No. 4,877,815 (Buckmaster et al.). To form a foamable fluoropolymer composition, the fluoropolymer is dry blended with the foam cell nucleating agent to provide a concentration thereof of 0.4 wt % based on the total weight of the fluoropolymer plus foam cell nucleating agent, and then the resultant mixture is compounded in an extruder and extruded as pellets, which are then used in the extrusion wire coating/foaming process. The fluoropolymer used to form the unfoamed regions of the polymer insulation is the same fluoropolymer by itself.

The conductor used in the Examples unless otherwise indicated is copper single strand wire having a diameter of 22.6 mils (565 μm). The polymer insulation of the Examples have a void content of 20% unless otherwise specified and have an unfoamed layer forming both surfaces of the polymer insulation. The unfoamed layers are formed by the same extruder providing the foamable polymer for the remainder of the polymer insulation. The unfoamed layer at the inner surface of the insulation is observable by viewing a cross section of the polymer-insulated conductor under magnification. The unfoamed exterior surface of the insulation is observable by the surface of the insulation being void free in appearance.

### EXAMPLE 1

The foamed polymer insulation of this Example resembles that of FIG. 2, wherein the 12 peaks are each 4 mils (0.1 mm) wide and 4 mils (0.1 mm) high and the overall insulation thickness is 11 mils (0.28 mm). The thickness of the insulation at the inner circumference defined by the valleys is 8 mils (0.2 mm). The diameter of the insulation from peak top to peak top is about 45 mils (1.143 mm). The peaks occupy about 41% of the inner circumference of the polymer insulation defined by the valleys.

When this polymer-insulated conductor is twinned with another of the same polymer-insulated conductors at a twinning rate of 2000 turns/min to form a lay of 0.3 in (7.6 mm) for the twisted pair, a peak of one insulation nests in a valley of the other insulation as a result of the back-twisting of the individual polymer-insulated conductors prior to twinning. The impedance of this twisted pair is 2 ohms greater than for a twisted pair of uniform thickness of a greater weight of polymer. In this comparison, the foamed polymer insulation with the peaks and valleys weighed 0.706 lb/1000 ft, while the foamed polymer insulation (same void content) weight 0.725 lb/1000 ft.

The greater crush resistance of the polymer insulation containing the peaks and valleys is manifested by improvement in impedance such as is demonstrated by this comparison.

### EXAMPLE 2

The foamed polymer insulation of this Example resembles that of FIG. 3, and is similar to the dimensions of the Example 1 embodiment except that the peaks are 6 mils (0.150 mm) wide. The peaks occupy about 62% of the inner circumference of the polymer insulation defined by the valleys. The impedance improvement for this polymer insulation in a nested twisted pair was 3 ohms as compared to a twisted pair of polymer insulation of the same weight but having a uniform thickness

### EXAMPLE 3

The foamed polymer insulation of this Example resembles that of FIG. 4, except that the peaks are 8 mils (0.2 mm) wide and 5 mils (0.13 mm) high and the insulation thickness from inner surface to the valleys (where the peaks interconnect) is 6 mils (0.150 mm).

### EXAMPLE 4

A coaxial cable is made by extrusion coating a copper conductor (same as above) by melt draw down extrusion with foamed fluoropolymer, followed by applying a metallized tape to the insulation and a braided wire covering over the tape to form the outer conductor of the coaxial cable. In one experiment, the foamed fluoropolymer insulation is 74 mils (1.88 mm) in diameter, and 0.918 lb (0.416 kg) of the fluoropolymer is used to produce 1000 ft (305 m) of the coaxial cable. In another experiment, the foamed insulation has twelve peaks resembling those of FIG. 2, but spaced further apart, and has the same overall diameter (from peak top to peak top). The amount of fluoropolymer to form this insulation is 0.721 lb (0.327 kg) to produce 1000 ft (305 m) of the cable, a 21% reduction in the amount of fluoropolymer needed to produce the same size and same length of coaxial cable. The void content of both insulations was 50%. This savings in polymer insulation amount is without sacrifice in electrical properties of the cable. Both coaxial cables exhibited a capacitance of 17 pF/ft, (56 pF/m) and velocity of signal propagation (VP) of 84%. The impedance of both cables is about 70 as calculated from the following equation: Impedance=101670/(capacitance×VP)

1. Communications cable comprising a conductor and polymer insulation encasing said conductor, said polymer insulation having a foamed interior and having an exterior surface formed from longitudinally running rounded peaks and valleys.

2. The communications cable of claim 1 wherein at least five of said peaks are present.

3. The communications cable of claim 1 wherein said peaks have a greater density than the density of said foamed interior.

4. The communications cable of claim 1 wherein said polymer insulation has an unfoamed layer present at said exterior surface, including the exterior surface of said peaks, or at the surface of said polymer insulation adjacent to said conductor or at both said surfaces.

5. The communications cable claim 1 wherein said peaks are unfoamed.

6. The communications cable of claim 1 wherein said peaks cover at least about 30% of said exterior surface of said polymer insulation and have a height that is at least about 50% of the width of said peaks.

7. The communications cable of claim 1 wherein the total thickness of said insulation is about 6 to 14 mils, and the height of said peaks is at least about 25% of said total thickness.

8. The communications cable combination of claim 1, wherein the polymer of said polymer insulation is fluoropolymer or non-fluorinated polymer.

9. The communications cable of claim 1, wherein said foamed polymer insulation has an average void content of at least 10%.

10. The communications cable of claim 1 wherein said peaks are non-folding when crushed.

11. Process for forming the communications cable of claim 1 comprising extruding a foamable molten thermoplastic polymer onto said conductor and foaming said polymer on said conductor to thereby obtain said encasing of said conductor to form said polymer insulation having a foamed interior, said extruding including forming said longitudinally running peaks and valleys as said exterior surface of said polymer insulation.

12. The process of claim 11 wherein said peaks have a greater density than the density of said foamed interior.

13. Process comprising extruding molten thermoplastic polymer through an orifice to coat a conductor passing through said orifice, thereby forming polymer insulation on said conductor, said orifice defining the exterior surface of said polymer insulation comprising longitudinally running rounded peaks and valleys, said peaks covering at least about 30% of said exterior surface and having a height that is at least 50% of the width of said peaks.

14. The process of claim 13 wherein that height of said peaks is no greater than about 150% of the width of said peaks.

15. The process if claim 13 wherein said extruding is pressure extruding or melt draw down extruding.

16. The process of claim 15 wherein said extruding is said melt draw down extruding, whereby said peaks are also drawn down, said peaks on the exterior surface of said polymer insulation thereby being smaller than as defined by said orifice.

17. The process of claim 15 wherein said melt draw down extruding is at a draw-down ratio of at least 50:1.

18. The process of claim 13 and additionally foaming said polymer insulation.

19. The process of claim 13 wherein said peaks are spaced apart from one another separated by said valleys.

20. The process of claim 13 wherein said peaks are interconnected, whereby said valleys are the intersection between said peaks.

21. The process of claim 13 wherein said polymer is fluoropolymer or non-fluorinated polymer.

22. An extrusion die for the extrusion of molten thermoplastic polymer onto a conductor to form polymer insulation thereon, said die having a surface forming the exterior surface of said polymer insulation, said die surface having a series of radially spaced, longitudinally running rounded grooves, whereby the exterior surface of said polymer insulation has longitudinally running rounded peaks and valleys, said peaks corresponding to said grooves in said die surface, said extrusion die including a guide for centering a conductor within said polymer insulation.
